(19) United States
(12) Patent Application Publication
(10) Pub. No.: US 2011/0039430 A1
(43) Pub. Date: Feb. 17, 2011

(54) FASTENING ASSEMBLY AND METHOD

(75) Inventor: Jeffrey M. Aftanas, Ortonville, MI (US)

Correspondence Address: HARNESS, DICKEY & PIERCE, P.L.C., P.O. BOX 828, BLOOMFIELD HILLS, MI, 48303, US

(73) Assignee: JAC-Rack, Inc., Pontiac, MI (US)

(21) Appl. No.: 12/856,039

(22) Filed: Aug. 13, 2010

Related U.S. Application Data
(60) Provisional application No. 61/233,951, filed on Aug. 14, 2009.

(51) Int. Cl. H01R 4/66

(52) U.S. Cl. 439/92

(57) ABSTRACT

A fastening and grounding apparatus adapted to be positioned against a channel of a metallic support frame member. A metallic bolt has a threaded shaft and an enlarged head portion at one end thereof. A metallic leaf spring has a central portion and a pair of opposing end portions, with the threaded shaft extending through the hole. At least one of the opposing end portions has a tooth projecting therefrom. The metallic leaf spring maintains the threaded shaft in an upright orientation extending from the channel. The tooth digs into a surface of the metallic support frame member to effect an electrical current signal path through the fastening apparatus to the metallic support frame member.

### CROSS-REFERENCE TO RELATED APPLICATIONS

This application claims the benefit of U.S. Provisional Application No. 61/233,951, filed on Aug. 14, 2009. The entire disclosure of the above application is incorporated herein by reference.

### TECHNICAL FIELD

The present disclosure relates to electrical grounding devices and methods, and more particularly to an electrical grounding device and method that enables positive electrical contact to be made between electrically conductive panels or components.

### BACKGROUND

This section provides background information related to the present disclosure which is not necessarily prior art.

In various applications, especially when connecting solar panel modules to a supporting frame structure, there is a need to make a ground connection between the metal frame of the module and the metal material of the supporting frame when the module is secured to the frame. Various types of metal washers have been proposed, with each having various limitations.

In many applications, especially those involving the assembly of solar panel modules onto a ground surface or a roof top, the need to be able to assemble the modules to a frame structure quickly, efficiently, and without the need for special tools, is also a major consideration.

### SUMMARY

This section provides a general summary of the disclosure, and is not a comprehensive disclosure of its full scope or all of its features.

The present disclosure in one aspect relates to a fastening and grounding apparatus adapted to be positioned against a metallic support frame member having a channel. The assembly may comprise a metallic bolt having a threaded shaft and an enlarged head portion at one end of the threaded shaft. A metallic leaf spring may be included that has a central portion and a pair of opposing end portions. The central portion may include a hole adapted to engage the threaded shaft. At least one of the opposing end portions may include a tooth projecting therefrom. The metallic leaf spring is adapted to be compressed when positioned on the metallic support frame member over the channel, and when applying a force to the threaded shaft directed toward the metallic support frame member, and the metallic leaf spring operating to maintain the threaded shaft in an upright orientation extending generally perpendicular to the channel of the metallic support frame member when the threaded shaft is released. The tooth digs into a surface of the metallic support frame to effect an electrical current signal path through the fastening apparatus to the metallic support frame member.

In another aspect the present disclosure relates to a fastening and grounding apparatus adapted to be positioned against a metallic support frame member having a channel. The assembly may comprise a metallic bolt having a threaded shaft and an enlarged head portion at one end of the threaded shaft. A metallic leaf spring may be included that has a central portion and a pair of opposing end portions. The central portion may include a hole adapted to engage the threaded shaft. Each of the opposing end portions may include a folded over section of material of the metallic leaf spring, with each of the folded over sections of material including a pair of teeth projecting in opposite directions. The metallic leaf spring may be compressed when positioned on the metallic support frame member over the channel, and when applying a force to the threaded shaft directed toward the metallic support frame member while the enlarged head portion is positioned within the channel of the metallic support frame member and oriented at a first position. The metallic leaf spring maintains the threaded shaft in an upright orientation extending generally perpendicular to the channel of the metallic support frame member when the head portion is rotated into a second position non-parallel to the first position and the threaded shaft is released. The teeth of each of the opposing end portions then dig into surfaces of the metallic support frame member, and also into a surface of a metallic frame portion of a photovoltaic panel positioned over the metallic leaf spring, to effect an electrical current signal path from the metallic frame portion, through the fastening apparatus and to the metallic support frame member.

In still another aspect the present disclosure relates to a fastening and grounding apparatus adapted to be positioned against a channel of a metallic support frame member. The assembly may comprise a metallic bolt having a threaded shaft and an enlarged, rectangular head portion at one end of the threaded shaft. A metallic leaf spring may have a central portion and a pair of opposing end portions. The central portion may include a hole adapted to engage the threaded shaft. The metallic leaf spring may have a width substantially the same as a width of the metallic support frame member. Each of the opposing end portions may include an integrally formed, folded over section of material of the metallic leaf spring. Each of the folded over sections of material may include a pair of teeth projecting in opposite directions. The metallic leaf spring is adapted to be compressed when positioned on the metallic support frame member over the channel, and when applying a force to the threaded shaft directed toward the metallic support frame member, while the enlarged head portion is positioned within the channel of the metallic support frame member at a first orientation. The metallic leaf spring maintains the threaded shaft in an upright orientation extending generally perpendicular to the channel of the metallic support frame member when the threaded shaft is rotated into a second orientation that is non-parallel to the first orientation and then released. The teeth of each of the opposing end portions dig into a surface of a frame portion of a photovoltaic panel that is positioned over the metallic leaf spring, and into a surface of the metallic support frame member, to effect an electrical current signal path from the frame portion, through the fastening apparatus and to the metallic support frame member.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a side view of one embodiment of the fastening assembly of the present disclosure;

FIG. 2 is a side view of the spring panel of the assembly of FIG. 1 but with a spring clip and a fastening member of the fastening assembly both rotated 90 degrees from the orientation shown in FIG. 1;

FIG. 3 is a perspective view of the fastening assembly;

FIG. 4 is a plan view of the spring clip with the threaded bolt removed;

FIG. 5 is an end view of just the spring clip of the fastening assembly;

FIG. 6 shows a first operation in using the fastening assembly to secure a frame portion of a solar panel module to a frame member, wherein a head portion of a fastening member of the assembly is orientated in a channel of the frame member; and

FIG. 7 shows the head portion pushed down and rotated 90 degrees to hold the spring clip, as well as the fastening member being used with a separate nut to secure the frame portion of the solar panel module to the frame member so that the spring clip ensures electrical contact between the frame portion and the frame member.

Corresponding reference numerals indicate corresponding parts throughout the several views of the drawings.

### DETAILED DESCRIPTION

Example embodiments will now be described more fully with reference to the accompanying drawings.

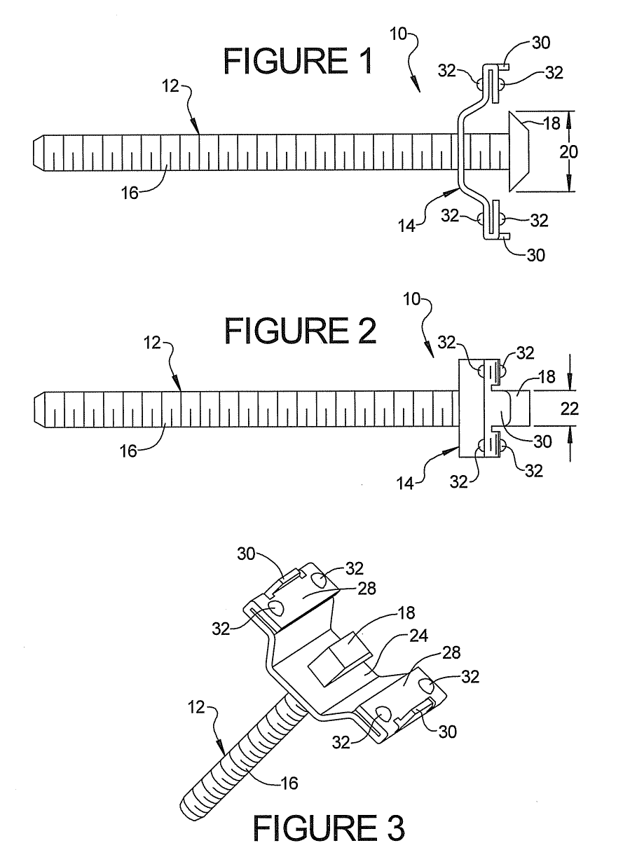

Referring to FIGS. 1 and 2, there is shown a fastening assembly 10 in accordance with one embodiment of the present disclosure. The fastening assembly 10 generally includes a threaded bolt 12 and a spring clip 14. The threaded bolt 12 has a threaded shaft 16 and a head portion 18. The head portion 18 has a first dimension, noted by arrow 20 in FIG. 1, that is longer than a second dimension 22, as indicated in FIG. 2. In one application, the length of the threaded shaft 16 is sufficient to extend through the thickness of a frame portion of a solar panel module so that the fastening assembly 10 can be used to secure a solar panel module to a frame member. However, it will be appreciated that the length and overall dimensions of both the threaded bolt 12 and the spring clip 14 will need to be adjusted to meet the requirements of the specific application at hand. The threaded bolt 12 may be made from any suitable metal or other material.

Referring to FIGS. 1 and 3-5, the spring clip 14 can be seen in greater detail. The spring clip 14 is preferably made from a resilient material, for example spring steel, although other materials having a degree of flexibility or resiliency may be employed. The spring clip 14 has a leaf-spring like shape that defines a central portion 24 with a hole 26, and opposing end portions 28. The opposing end portions 28 may each be formed by a folded over section of material, as best visible in FIGS. 1 and 3, and each includes a generally perpendicularly extending tab 30 as seen in FIG. 3. On each opposing end portion 28 is a projecting tooth 32 that may be formed by simply partially punching out a small portion of material from the opposing end portions 28 before the portions 28 are folded over onto one another. This way when the opposing end portions 28 are folded over to take the shape as shown in FIG. 3, the projecting teeth 32 will be projecting in opposing directions. This feature is shown particularly well in FIG. 5. The tabs 30 may have a width, as defined by arrow 34 in FIG. 5, that allows the tab to rest in a channel of a frame member, as will be explained further in the following paragraphs.

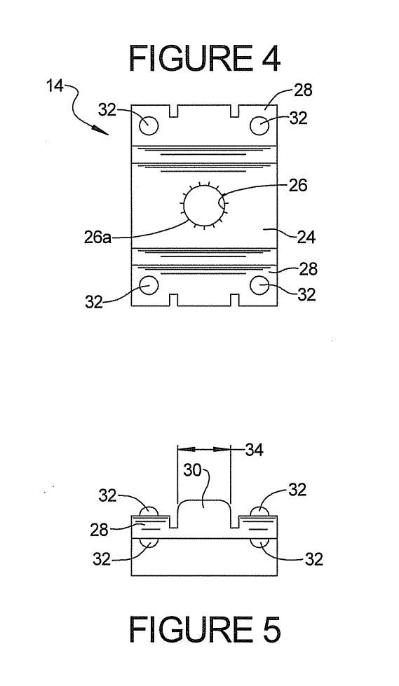

The hole 26 (FIG. 4) preferably also has a plurality of radial cuts or slots that enables the threaded shaft 16 of the bolt 12 to be more easily threaded into and through the spring clip 14. For the solar panel application mentioned herein, the diameter of the threaded shaft 16 will also preferably be selected so that the threaded shaft 16 can extend through a channel formed in the frame member of the solar panel module.

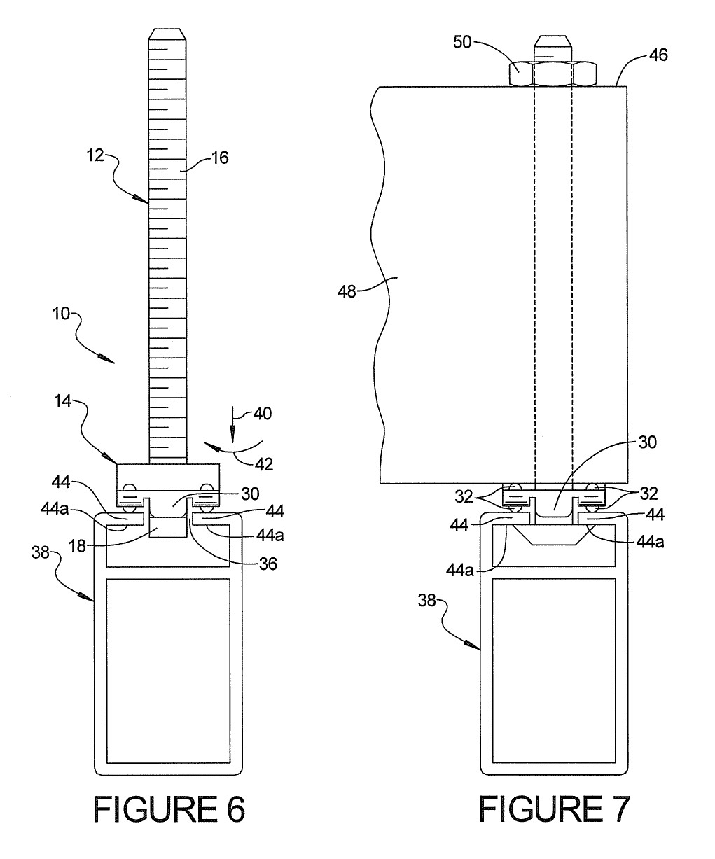

Referring now to FIGS. 6 and 7, the use of the fastening assembly 10 in securing a solar panel module to a frame member will be described. In FIG. 6 the fastening assembly is first placed with the head portion 18 of the threaded bolt 12 in a channel 36 of a frame member 38. The head portion 18 is oriented so that its narrower dimension can be extended part way into the channel 36. The user then grasps the threaded shaft 16 and pushes in a downward direction in accordance with arrow 40 with sufficient force to flatten the spring clip 14. While the spring clip 14 is held in its flattened orientation, the user rotates the threaded shaft 16 in accordance with directional arrow 42 so that the head portion 18 is turned about 90 degrees into the orientation shown in FIG. 7. When the user releases the threaded shaft 16, the spring clip 14 maintains the head portion 18 against the inside surfaces 44a of shoulder portions 44 of the frame member 38, as shown in FIG. 7. At this point, the user may adjust the longitudinal positioning of the fastening assembly 10 along the length of the frame member 38 as needed. FIG. 7 illustrates the threaded shaft 16 of the threaded bolt 12 having been inserted through a suitable opening in a frame portion 46 of a solar panel module 48. Once nut 50 is tightened down, the teeth 32 are able to dig or “bite” into the metallic surfaces of the frame member 38 and the frame portion 46, and form an electrically conductive grounding path through the spring clip 14. Typically the frame member 38 will be coupled to ground via a suitable cable. Thus, the fastening assembly 10 not only functions to provide a quick and easy to use mechanism for securing the solar panel 48 to the frame member 38, but also a mechanism for automatically creating an electrically conductive path between the two frame components 46 and 38.

The ability of the fastening assembly 10 to hold the threaded bolt 12 in an upright manner within the channel 36 of the frame member is a significant benefit. Often the frame member 38 is several feet long, and often can be 4 foot, eight foot, or even longer in overall length. The ability of the user to position the fastening assembly 10 at a desired, approximate point along the length of the frame member 38 is a significant advantage in reducing the assembly time required for the user to install a solar panel system. Often such systems may involve several, or possibly dozens or even hundreds of independent solar panel modules that must be installed on a plurality of frame members with suitable grounding washers or like implements being used with the fasteners that are used to fasten the modules to their respective frame members. With previously developed grounding implements adapted to fit in a channel of a frame member, the grounding implement often needs to be inserted at one end of the channel and then slid to the approximate longitudinal point along the channel where it will be fastened. This can take considerable time, especially in installations where dozens or hundreds of solar panel modules are being installed. The fastening assembly 10 of the present disclosure enables it to be inserted directly into the channel at the approximate point where the user anticipates it will be fastened to the frame member 38, thus eliminating the need to install it from one open end of the channel.

While the fastening assembly 10 has been described as being well suited for use in the assembly of solar panel systems, it will be appreciated that the fastening assembly is also expected to find utility in a wide variety of other applications as well. The fastening system 10 may be used in virtually any application where two components need to be secured together, and an electrically conductive path formed between them as the securing operation is completed.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fastening and grounding apparatus adapted to be positioned against a metallic support frame member having a channel, the assembly comprising:
a metallic bolt having a threaded shaft and an enlarged head portion at one end of the threaded shaft, the enlarged head portion having dimensions enabling it to be inserted and retained within the channel;
a metallic leaf spring having a central portion and a pair of opposing end portions, the central portion including a hole adapted to engage the threaded shaft;
at least one of the opposing end portions including a tooth projecting therefrom;
said metallic leaf spring adapted to be compressed when positioned on the metallic support frame member over the channel, and when a force is applied to the threaded shaft directed toward the metallic support frame member, and the metallic leaf spring operating to maintain the threaded shaft in an upright orientation extending generally perpendicular to the channel of the metallic support frame when the threaded shaft is released and the enlarged head portion is positioned within the channel; and
the tooth at the at least one opposing end portion digging into a surface of the metallic support frame to effect an electrical current signal path through the fastening apparatus to the metallic support frame member.

2. The fastening apparatus of claim 1, wherein each of the opposing end portions includes a tab projecting generally perpendicularly therefrom, the tab serving to engage a slot of the channel and to align the metallic leaf spring with the channel of the metallic support frame member.

3. The fastening apparatus of claim 2, wherein the tab has a width generally in accordance with a width of the slot of the channel of the metallic support frame member.

4. The fastening apparatus of claim 1, wherein each of the opposing end portions is formed from a folded over section of material.

5. The fastening apparatus of claim 1, wherein the central portion includes a plurality of radial slots that help facilitate threaded engagement of the threaded shaft of the metallic bolt, and which enable the central portion of the metallic leaf spring to be pushed linearly along the threaded shaft.

6. The fastening apparatus of claim 1, wherein the head of the metallic bolt has a rectangular shape that includes dimensions selected in relation with dimensions of an interior of the channel of the metallic support frame member.

7. The fastening apparatus of claim 1, wherein the central portion and the opposing end portions each has a width substantially in accordance with a width of the metallic support frame member.

8. The fastening apparatus of claim 1, wherein each of the opposing end portions includes two pairs of teeth, with the two pairs of teeth at each of the opposing end portions projecting in opposite directions.

9. A fastening and grounding apparatus adapted to be positioned against a metallic support frame member having a channel, the apparatus comprising:
a metallic bolt having a threaded shaft and an enlarged head portion at one end of the threaded shaft;
a metallic leaf spring having a central portion and a pair of opposing end portions, the central portion including a hole that engages the threaded shaft;
each of the opposing end portions including a folded over section of material of the metallic leaf spring, with each of the folded over sections of material including a pair of teeth projecting in opposite directions;
the metallic leaf spring adapted to be compressed when the metallic leaf spring is positioned on the metallic support frame member overlaying the channel, and while applying a force to the threaded shaft directed toward the metallic support frame member while the enlarged head portion is positioned within the channel of the metallic support frame member and oriented at a first position, and the metallic leaf spring operating to maintain the threaded shaft in an upright orientation extending generally perpendicular to the channel of the metallic support frame member when the head portion is rotated into a second position non-parallel to the first position and the threaded shaft is released; and
the teeth of each of the opposing end portions digging into surfaces of the metallic support frame member, and also into a surface of a metallic frame portion of a photovoltaic panel positioned over the metallic leaf spring, to effect an electrical current signal path from the metallic frame portion, through the fastening apparatus and to the metallic support frame member.

10. The apparatus of claim 9, wherein the enlarged head portion forms a rectangular shape having dimensions permitting it to be positioned completely within the channel of the metallic support frame member.

11. The apparatus of claim 9, wherein the opposing end portions each include a tab projecting outwardly therefrom.

12. The apparatus of claim 11, wherein each of the tabs has a width generally in accordance with a slot of the channel of the metallic support frame member.

13. The apparatus of claim 12, wherein each of the tabs is integrally formed from a portion of its associated said opposing end portion.

14. The apparatus of claim 13, wherein the hole in the central portion includes a plurality of radially extending slits to facilitate insertion of the threaded shaft of the metallic bolt therethrough, and further enables the central portion to be pushed linearly along the threaded shaft.

15. A fastening and grounding apparatus adapted to be positioned against a channel of a metallic support frame member, the assembly comprising:
a metallic bolt having a threaded shaft and an enlarged, rectangular head portion at one end of the threaded shaft;
a metallic leaf spring having a central portion and a pair of opposing end portions, the central portion including a hole adapted to engage the threaded shaft, the metallic leaf spring having a width substantially the same as a width of the metallic support frame member;
each of the opposing end portions including an integrally formed, folded over section of material of the metallic leaf spring, with each of the folded over sections of material including a pair of teeth projecting in opposite directions;
the metallic leaf spring adapted to be compressed when the metallic leaf spring is positioned on the metallic support frame member overlaying the channel, and when applying a force to the threaded shaft directed toward the metallic support frame member while the enlarged head portion is positioned within the channel of the metallic support frame member at a first orientation, and the metallic leaf spring operating to maintain the threaded shaft in an upright orientation extending generally perpendicular to the channel of the metallic support frame member when the threaded shaft is rotated into a second orientation that is non-parallel to the first orientation and then released; and
the teeth of each of the opposing end portions digging into a surface of a frame portion of a photovoltaic panel that is positioned over the metallic leaf spring, and into a surface of the metallic support frame member, to effect an electrical current signal path from the frame portion, through the fastening apparatus and to the metallic support frame member.

16. The apparatus of claim 15, wherein the teeth are integrally formed on the folded over sections of material.

17. The apparatus of claim 15, further comprising a tab extending perpendicularly from each of the opposing end portions.

18. The apparatus of claim 17, wherein the tabs have dimensions enabling them to extend into a slot of the channel of the metallic support frame member to assist in maintaining the metallic leaf spring aligned along the metallic support frame member.

19. The apparatus of claim 17, wherein the tabs are integrally formed from portions of material of the opposing end portions.

20. The apparatus of claim 17, wherein the hole in the central portion includes a plurality of radially extending slits to facilitate insertion of the threaded shaft, and further to assist in enabling the central portion to be pushed linearly along the threaded shaft.
